(19) United States
(12) Patent Application Publication
(10) Pub. No.: US 2024/0265345 A1
(43) Pub. Date: Aug. 8, 2024

(54) SYSTEM FOR THE INVENTORY MONITORING OF GOODS

(71) Applicant: Julius Blum GmbH, Hoechst (AT)

(72) Inventor: Klaus Mattle, Koblach (AT)

(21) Appl. No.: 18/638,180

(22) Filed: Apr. 17, 2024

Related U.S. Application Data
(63) Continuation of application No. PCT/AT22/60339, filed on Sep. 29, 2022.

(30) Foreign Application Priority Data
Oct. 18, 2021 (AT) A 50829/2021

(51) Int. Cl. G06Q 10/087; G06Q 30/0601

(52) U.S. Cl. CPC G06Q 10/087; G06Q 30/0633

(57) ABSTRACT

A system includes a furniture part which is movable, a good such as food, the good being separate, preferably spatially separate, from the furniture part; a mobile terminal; and a plurality of smart tags for identifying the good. At least one of the smart tags can be arranged on the furniture part and/or can be removed from the furniture part, and the furniture part includes a data transfer module. The data transfer module is designed to transfer to the mobile terminal at least one digital data set concerning a smart tag which can be arranged on the furniture part and/or can be removed from the furniture part.

The present application is a continuation of International Application PCT/AT2022/060339 filed Sep. 29, 2022. Thus, all of the subject matter of International Application PCT/AT2022/060339 is incorporated herein by reference.

### BACKGROUND OF THE INVENTION

The invention relates to a system for the inventory monitoring of goods, comprising at least one, in particular movable, furniture part, at least one good, in particular foodstuff, wherein the at least one good is, preferably spatially, separate from the at least one furniture part, at least one mobile terminal and a plurality of smart tags for the identification of the at least one good. The invention also relates to a method for the inventory monitoring of goods, in particular using such a system. The invention further relates to a computer program product, a data carrier signal and a storage medium.

A system for the inventory monitoring of goods is already known from the document DE 10 2014 110 866 A1, in which goods can be detected and managed directly on the piece of furniture. For this, a weight detection system is used, with the aid of which recipe suggestions can be derived. How much of the good has been consumed can be inferred via a positioning of the goods in the piece of furniture and a weighing process. A disadvantage here in particular is that the original amount of the good must be laboriously identified on the specific good, then stored reliably and continuously compared with the actual status via the complex weight detection system, which results in a system that is inconvenient and expensive for the user of the system. In addition, the weight detection system must be calibrated and maintained in order to be able to monitor the inventory of the goods precisely. Furthermore, the inventory monitoring is restricted to the number of segments and bound to the segments as a source of information for the inventory.

A further system for the inventory monitoring of goods is already known from the document DE 602 14 991 T2, wherein, to take an inventory inside an object such as a refrigerator, barcodes of products are scanned by a reading device of the object in order to be able to keep an inventory list. A disadvantage here in particular is that a separate reading device is necessary for each object in which goods are to be stored and monitored, and an application area is restricted to the dimensions of the object, as a result of which an external use of the information relating to the goods is limited. Moreover, it is not possible to differentiate between new and consumed goods and an identification is restricted to the location in the object.

### SUMMARY OF THE INVENTION

The objective technical problem of the present invention is therefore to specify a system for the inventory monitoring of goods that is improved compared with the state of the art and a method for the inventory monitoring of goods, in which the disadvantages of the state of the art are at least partially remedied, and which are characterized in particular by a flexible and convenient differentiation between consumed and non-consumed goods and make a broad application area of information relating to the current inventory of goods possible without being restricted to a localization of the goods.

According to the invention, out of a plurality of smart tags, at least one smart tag is and/or can be arranged, preferably directly, on the at least one furniture part and/or is and/or can be removed from the at least one furniture part and the at least one furniture part comprises at least one data transfer module. The at least one data transfer module is set up to transfer at least one digital data set relating to at least one smart tag that is and/or can be arranged on the at least one furniture part and/or is and/or can be removed from the at least one furniture part to the at least one mobile terminal.

As a result, it is possible for the first time that the at least one good does not need to be located at a specific place and continuously monitored. The data in connection with the at least one data set can be used as a source of information for a wide variety of purposes remote from the system. A user-specific configuration can be adapted flexibly, wherein a configuration of the smart tags can also be set up in a user-friendly manner without additional components remote from the at least one mobile terminal. In addition, for example, non-mobile groups of people can be conveniently supported remotely in replenishing the inventory of the goods-without having to obtain an overview of the goods inventory on site.

Via the at least one digital data set, it is also possible to support the user of the system in selecting products through advertising or to make them aware of promotions relating to the used goods or of healthier or higher quality alternatives. Via statistical evaluations, the user of the system can obtain an overview of a history of their consumption or a consumption of a relative. Different groups of people and/or groups of goods can be differentiated. The at least one smart tag can be re-initialized when used with a new good, in order to reuse the at least one smart tag. The number of already configured smart tags on the at least one piece of furniture in conjunction with a history of digital data sets reflects the specific consumption of the goods, which can be adjusted with reference to a diet plan, for example.

In this context, the fact that the at least one data transfer module is set up for the transfer of the at least one digital data set means that the at least one data transfer module is programmed for this specific function-for example via the at least one mobile terminal.

The at least one furniture part serves as an intermediary between the at least one mobile terminal for data evaluation, such as the creation of a shopping list or interface to sales or to a facility for producing the goods, and the system user's goods, the inventory of which is of interest. In general, any desired object such as pharmaceuticals, foodstuffs, office supplies or the like can be regarded as a good.

There is also the positive property that the individual smart tags, merely via their location, give information about a good that is still available or a good that has already been consumed, wherein the at least one data transfer module can be arranged on any furniture part and can relay a complete overview of the inventory to the at least one mobile terminal. The positioning of the goods remote from the at least one furniture part is generally unimportant. The configuration of the individual smart tags can in turn be effected from the at least one mobile terminal, with the result that a direct proximity to the smart tags is not necessary and an overview of the usage of the smart tags can be guaranteed via a suitable visualization of the smart tags on the at least one mobile terminal.

It is also possible that a delegation of at least one smart tag is detected by the at least one furniture part, as a result of which a particularly effective inventory monitoring can be generated by accounting for goods in the inventory and/or goods can be identified which have been included in the inventory through a purchase and/or which have not yet been included in the inventory through a purchase.

According to the invention, the placing and/or removal of at least one smart tag is transmitted via the at least one data transfer module—in particular indirectly via a data network—to the at least one mobile terminal, preferably smartphone, tablet and/or computer, in order to monitor an inventory of goods and possibly to create a shopping list, for example, wherein possibly at least one smart tag is arranged on the at least one good.

If a cloud is used, the at least one digital data set can be used in a decentralized manner on the at least one mobile terminal, as an alternative or in addition to a central usage, in order to allow further groups of people such as relatives, sales partners, production facilities et cetera to share the inventory and the goods specifically involved in the inventory, with the result that specific, personalized offers can be transmitted to the at least one mobile terminal. Instead of a cloud, a server can generally also be used. The at least one mobile terminal is preferably set up to receive the at least one digital data set from the at least one data transfer module and/or to transmit the at least one digital data set-possibly in digitally transformed form-to the cloud or the server.

Moreover, the at least one furniture part can take on the inventory monitoring, with the result that the at least one mobile terminal can create shopping lists for goods in an efficient and effective manner—possibly with automatically generated suggestions—as a result of which in particular transport distances can be reduced and/or an improved overview of a consumption of goods can be guaranteed. In the case of a reduction of goods below a threshold value to be defined, a digital message can be sent automatically to the at least one mobile terminal and/or the digital shopping list can be updated.

A further positive aspect is that it can be quickly recognized which specific goods have already been in stock for how long, in order to be able to initiate a consumption of the goods or an adaptation of future buying behavior if necessary.

The provision of personalized product placements, user-specific push notifications, online offers in decision-making can be supportive with regard to time management, wherein a resource-saving combination of purchases is made possible via the system according to the invention. The adaptation of the system to changed requirements and/or circumstances can be effected via a configuration of the at least one mobile terminal. A buying behavior can be monitored and used for suitable recipe suggestions. A quick relaying of information with respect to the inventory of the at least one good can be effected conveniently.

If personalized advertising in combination with user-specific offers and possibly links to sales and/or production facilities are provided for the user on the at least one mobile terminal, the data transfer of the at least one digital data set via the at least one data transfer module as an additional interface results in a business-to-customer win-win situation.

As stated at the beginning, protection is also sought for a method for the inventory monitoring of goods, in particular using such a system, wherein the following method steps are carried out, in particular in chronological order:
at least one smart tag out of a plurality of smart tags is possibly arranged, preferably directly, on a good, preferably foodstuff, that is, preferably spatially, separate from at least one, preferably movable, furniture part,
the at least one smart tag is arranged, in particular after consumption of the at least one good and/or directly, on the at least one furniture part, and
at least one data transfer module, arranged on the at least one furniture part, of the at least one furniture part transfers at least one digital data set relating to the at least one smart tag arranged on the at least one furniture part to at least one mobile terminal, preferably smartphone, tablet and/or computer.

As stated at the beginning, protection is also sought for a method for the inventory monitoring of goods, in particular using such a system, wherein the following method steps are carried out, in particular in chronological order:
at least one smart tag out of a plurality of smart tags is removed from the at least one furniture part and possibly arranged on at least one good that is separate from the at least one furniture part and
at least one data transfer module, arranged on the at least one furniture part, of the at least one furniture part transfers at least one digital data set relating to the at least one smart tag removed from the at least one furniture part to at least one mobile terminal, preferably smartphone, tablet and/or computer.

As stated at the beginning, protection is also sought for a computer program product, comprising commands which, when executed by a computing unit, prompt the latter to transfer at least one digital data set relating to at least one smart tag that is arranged on, able to be arranged on, removed from and/or able to be removed from the at least one furniture part from a storage unit, which is or can be brought into data connection with the computing unit, to at least one mobile terminal for carrying out such a method.

As stated at the beginning, protection is also sought for a data carrier signal which carries such a computer program product.

As stated at the beginning, protection is also sought for a storage medium, in particular non-volatile storage medium, comprising commands which, when executed by a computing unit, prompt the latter to transfer at least one digital data set relating to at least one smart tag that is arranged on, able to be arranged on, removed from and/or able to be removed from the at least one furniture part to at least one mobile terminal for carrying out such a method and/or executing such a computer program product.

For example, the computer program product can be in the form of an algorithm of an app or the app for the at least one mobile terminal. The data carrier signal can be a download for the app, for example. The storage medium can, for example, be in the form of a CD, a USB stick or a digital storage area on which the computer program and/or the app is located.

According to an advantageous design of the invention, a switch, a router, and/or a cloud is provided, wherein the at least one digital data set can be relayed from the at least one furniture part to the at least one mobile terminal via the switch, the router and/or the cloud.

A data transfer protocol for the switch, the router and/or the at least one mobile terminal, in particular smartphone, for transferring data of the at least one digital data set into the cloud is generally as desired. Wi-Fi in the form of WLAN and/or WAN is preferably used.

For example, a voice control, in particular a voice-controlled device and/or in conjunction with a shopping list, can also be used.

It is advantageously provided that there is at least one smart tag in the form of an RFID chip, an NFC tag and/or a, preferably programmable, chip.

However, the technology of the at least one smart tag is generally as desired, and transponders which guarantee an identification of goods and in particular, via the at least one data transfer module, a differentiation between consumed goods and non-consumed goods, the smart tags of which are not delegated to the at least one furniture part, are also conceivable as smart tags. However, a procedure of scanning a barcode via a reading device is not necessary.

It has proved to be beneficial that the at least one data transfer module is set up:
to identify, preferably iteratively or jointly, all smart tags arranged on the at least one furniture part by communicating with the respective smart tags and/or
to transfer exactly one digital data set relating to all smart tags arranged on the at least one furniture part collectively to the at least one mobile terminal and/or
to transfer, iteratively, digital data sets relating in each case to exactly one smart tag arranged on the at least one furniture part to the at least one mobile terminal and/or
to store the at least one digital data set, preferably initiated by placing at least one smart tag on the at least one furniture part, in a buffer integrated in the at least one data transfer module, wherein it is preferably provided that the buffer can be at least partially emptied via the at least one mobile terminal and/or through a data transfer from the at least one data transfer module to the at least one mobile terminal, and/or
to initiate a data transfer of the at least one digital data set in the case of a query through the at least one mobile terminal and/or
to initiate a data transfer of the at least one digital data set when a connection to the at least one mobile terminal is produced and/or when a number of smart tags arranged on the at least one furniture part changes.

The data transfer of the at least one digital data set can be effected as desired according to the wish of the user of the system and can be adapted flexibly.

According to an advantageous embodiment of the invention, the at least one mobile terminal is formed as a smartphone, tablet and/or computer, preferably notebook or laptop, wherein it is preferably provided that at least one app for monitoring the plurality of smart tags is stored on the at least one mobile terminal, wherein, with the at least one app, at least one smart tag can be identified with at least one good and/or at least one smart tag can be programmed for identification, particularly preferably 1:1 identification, with at least one good.

This makes it possible that, via a smart tag identified with a good, through the at least one data transfer module and/or the at least one mobile terminal, via the positioning on the at least one furniture part, consumed goods can be identified, wherein the at least one data transfer module preferably differentiates between configured and non-configured smart tags on the at least one furniture part, even in the absence of separating areas of the at least one furniture part.

If a smart tag previously configured with a goods category or a specific good is no longer required, then the smart tag can for example be set to a default value and/or be allocated to non-configured smart tags.

It has proved to be advantageous for the at least one mobile terminal to be formed to visualize the at least one digital data set and/or to categorize the plurality of smart tags based on the at least one digital data set, wherein preferably a digital message can be output on the at least one mobile terminal based on the at least one digital data set.

This makes it possible to present the inventory in overview and/or in a visually appealing manner to the user of the system at a glance.

An advantageous variant of the present invention is that the at least one mobile terminal is set up to create, preferably automatically, a shopping list based on the at least one digital data set and possibly taking into consideration a number of smart tags on the at least one good. Preferably, a data analysis of the at least one digital data set can be generated, particularly preferably taking into consideration a history of digital data sets and/or predicted digital data sets.

The shopping list can be generated automatically via an app on the at least one mobile terminal and/or in the cloud, wherein a shopping list generated in the cloud is preferably transmitted to the at least one mobile terminal. In the automatic creation of the shopping list and/or the creation of advertising, artificial intelligence is particularly preferably used, wherein the artificial intelligence can also be used for example in order to monitor expiry dates of goods, to reduce shortages or deterioration of goods and/or to generate suggestions for healthier shopping lists. The artificial intelligence can comprise processes such as deep learning, machine learning and/or neural networks. Aside from artificial intelligence, suitable algorithms can be used.

It is particularly preferred that the at least one mobile terminal is set up to transfer the at least one digital data set to a cloud, preferably via a possibly present switch and/or a possibly present router. It is preferable that, in the cloud, based on the at least one digital data set,
the plurality of smart tags can be categorized and/or
a digital message can be transmitted to the at least one mobile terminal and/or
a shopping list can be created, preferably taking into consideration a number of smart tags on the at least one good and/or automatically, and/or
a data analysis of the at least one digital data set can be generated, preferably taking into consideration a history of digital data sets and/or predicted digital data sets.

This makes it possible to use the information of the configured smart tags arranged on the at least one furniture part in a decentralized manner, wherein a smart tag identified with a good or a goods category provides data relating to the currently present goods inventory to the at least one mobile terminal and/or the cloud via the at least one data transfer module for the user of the system to view and/or for further use.

In an embodiment of the invention, the at least one data transfer module comprises a receive device for the identification, by radio signal transmission, of the smart tags arranged on the at least one furniture part and/or a send device for the transmission, by radio signal transmission, of the at least one digital data set. Preferably, the at least one data transfer module comprises a computing unit and/or a storage unit, particularly preferably buffer.

The at least one data transfer module can consequently act as an interpreter between smart tags and the at least one mobile terminal, and the at least one digital data set is processed for example on the at least one data transfer module and/or on the at least one mobile terminal on the basis of the connection with the at least one smart tag.

According to a preferred embodiment of the invention, the at least one furniture part is formed in the form of a container and/or a drawer. Preferably, the at least one furniture part comprises a separating device for the at least one smart tag arranged on the at least one furniture part, and at least one separating area for configured smart tags, at least one separating area for unconfigured smart tags and/or at least two separating areas for placing smart tags of at least two different groups and/or at least one securing device for the at least one smart tag is provided on the at least one furniture part.

If the at least one furniture part is designed as a drawer, the system can be integrated in an existing furniture arrangement in an esthetically appealing manner.

Separating areas make it possible to effect a grouping according to goods and/or goods categories, according to the type of the smart tags, according to different users of the system and/or according to economically separate groups of people. A separating area divides the at least one furniture part into at least two furniture areas that are not connected to each other, wherein for example a separate storage space for securing devices can be generated.

The at least one securing device can, for example, represent a clothespin, a hook and loop fastener, an elastic band, a cord or another coupling agent for joining smart tags to goods.

It is particularly preferable that the at least one data transfer module is an integral part of the at least one furniture part and/or is integrated at least in areas, preferably entirely, in the at least one furniture part or is arranged inside the at least one furniture part.

It has proved to be beneficial that, based on the at least one digital data set, on the at least one mobile terminal, via at least one app for monitoring the plurality of smart tags stored on the at least one mobile terminal, and/or in the cloud, after a data transfer of the at least one digital data set from the at least one mobile terminal into the cloud,
at least one smart tag is identified with at least one good and/or at least one smart tag is programmed for identification, particularly preferably 1:1 identification, with at least one good, and/or
at least one digital data set is visualized and/or the plurality of smart tags are categorized based on the at least one digital data set, wherein it is preferably provided that a digital message is output on the at least one mobile terminal based on the at least one digital data set, and/or
a shopping list is created, preferably automatically, based on the at least one digital data set and possibly taking into consideration a number of smart tags on the at least one good, and/or
a data analysis of the at least one digital data set is generated, preferably taking into consideration a history of digital data sets and/or predicted digital data sets.

Furthermore, preferably, on the basis of the data analysis, preferably in a user-specific and/or decentralized manner, a statistical evaluation of at least one digital data set is created, advertising adapted to the at least one digital data set is visualized on the at least one mobile terminal and/or the at least one digital data set is relayed to at least one production facility and/or sales facility.

### BRIEF DESCRIPTION OF THE DRAWINGS

The features of the system claims can be applied to the method claims, and vice versa. Further details and advantages of the present invention are explained in more detail below with reference to the figures, in which:

FIG. 1 shows a system according to a preferred embodiment in a schematic representation for the inventory monitoring of goods, and

FIG. 2 shows a system according to a further preferred embodiment for the inventory monitoring of goods, in a schematic representation.

### DETAILED DESCRIPTION OF THE INVENTION

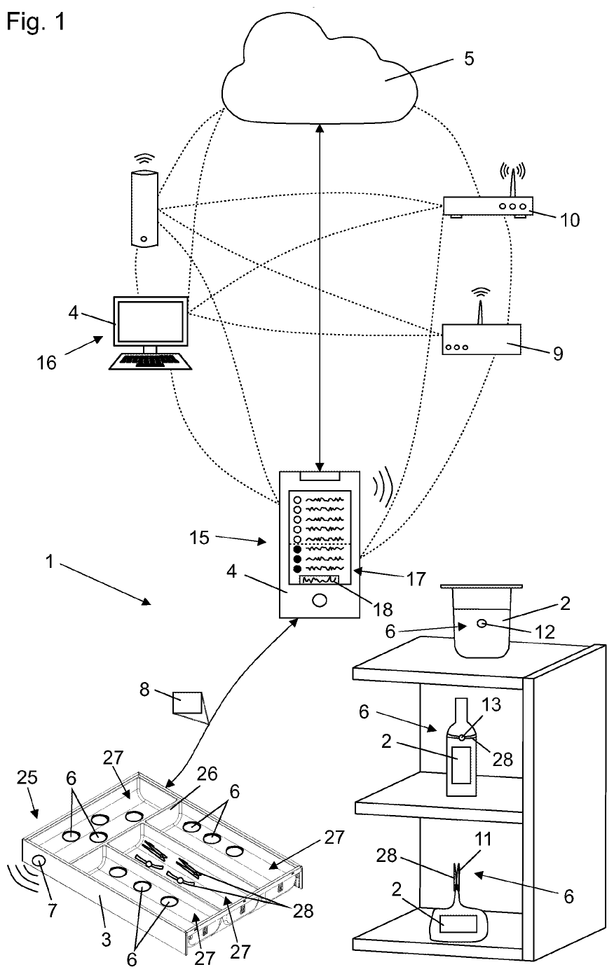

FIG. 1 shows a system 1 for the inventory monitoring of goods 2, comprising a furniture part 3 that is movable relative to a furniture carcass of a piece of furniture, not represented for reasons of clarity, and three goods 2 in the form of foodstuffs, wherein the goods 2 are spatially separate from the furniture part 3. The goods 2 are arranged on a further piece of furniture.

A mobile terminal 4 is provided for data communication with a cloud 5 and a plurality of smart tags 6 are provided for the identification of the goods 2 in the system 1.

The mobile terminal 4 is in the form of a smartphone 15 and is connected in a radio-signal-conducting manner to a computer 16 as a notebook. However, a data communication of the involved components of the system 1 can generally also be designed wired.

The smart tags 6 are in the form of RFID chips 11, NFC tags 12 and programmable chips 13. However, in general all smart tags 6 can also be formed as chips 13, for example.

Out of the plurality of smart tags 6 of the system 1, some smart tags 6 are arranged directly on the furniture part 3, wherein three smart tags 6 are arranged on the goods 2. In general, several goods 2 can also be arranged with a joint smart tag 6 or several smart tags 6 can be arranged on one good 2.

The furniture part 3 comprises a data transfer module 7, wherein the data transfer module 7 is set up to transfer digital data sets 8 relating to at least one smart tag 6 arranged on the furniture part 3 to the mobile terminal 4.

Analogously, the data transfer module 7 can transfer digital data sets 8 relating to at least one smart tag 6 that has been removed from the furniture part 3 to the mobile terminal 4. In general, the arrival of smart tags 6, the departure of smart tags 6 or merely the arrival or departure of smart tags 6 relative to the furniture part 3 can be identified and transmitted by the data transfer module 7. For example, for this the mobile terminal 4 comprises a data input module and/or a data output module for data communication with the data transfer module 7 and/or the cloud 5.

The implementation is effected via a computer program product, which has been stored on the mobile terminal 4 via a data carrier signal in the form of an app download and on the data transfer module 7 in the form of a storage area as storage medium.

The mobile terminal 4 comprises a piece of software in the form of a program as app 17 for monitoring the plurality of smart tags 6, wherein, with the app 17, smart tags 6 can be identified with goods 2 and smart tags 6 can be programmed for 1:1 identification with a good 2.

A switch 9, a router 10 and a cloud 5 are provided within the system 1, wherein, as an alternative or in addition to a preferred direct transmission to the mobile terminal 4, the digital data set 8 can also be relayed from the furniture part 3 to the mobile terminal 4 via the switch 9, the router 10 or the cloud 5.

The mobile terminal 4 is formed to visualize digital data sets 8 separately or together and, based on the digital data sets 8, to categorize the plurality of smart tags 6. In the schematically represented embodiment of the app 17, the digital data sets 8 which correspond to smart tags 6 on goods 2 and smart tags 6 on the furniture part 3 are in two categories of already consumed good 2 (configured smart tags 6, which are delegated to the furniture part 3) and at least partly unconsumed good 2 (configured smart tags 6, which are not delegated to the furniture part 3).

For example, a specific half-consumed good 2 can be notified to the monitoring system of the mobile terminal 4 in that one of two smart tags 6 arranged on the specific good 2 is arranged on the furniture part 3.

For example, a smart tag 6 can be referenced with a specific good 2—such as a particular wine bottle—or a category of a good-such as wine.

Based on the digital data sets 8, a digital message 18, which for example comprises an item of information in the form of a pop-up to a user of the system 1 which contains a change in the inventory of smart tags 6 arranged on the furniture part 3, an empty state of goods 2, personalized product information such as discounts or alternatives to already bought goods 2 or a warning of low stocks of a good 2, can be output on the mobile terminal 4.

The furniture part 3 is in the form of a drawer 25, wherein the furniture part 3 comprises a separating device 26 for smart tags 6 already located in the system 1 or to be added to the system 1. The furniture part 3 comprises a separating area 27 for configured smart tags 6, which inform the user of the system 1 of consumed goods 2, a separating area 27 for unconfigured smart tags 6, which can still be configured with goods 2, a separating area 27 for securing devices 28, via which the smart tags 6 can be mechanically connected to the goods 2, and a separating area 27 for placing smart tags 6 of a group which the system 1 uses together with a further group. However, the number of separating areas 27 is generally as desired and can be flexibly adapted to the system 1 according to requirements.

The mobile terminal 4 Is set up t″ tra′sfer the digital data set 8 to the cloud 5 via the switch 9 and the router 10.

A voice-controlled device in the form of a—preferably internet-based—intelligent personal assistant is provided within the system 1 in order to make a particularly convenient inventory monitoring possible for the user and, for example, to add to or retrieve the shopping list or to acoustically notify changes in the inventory.

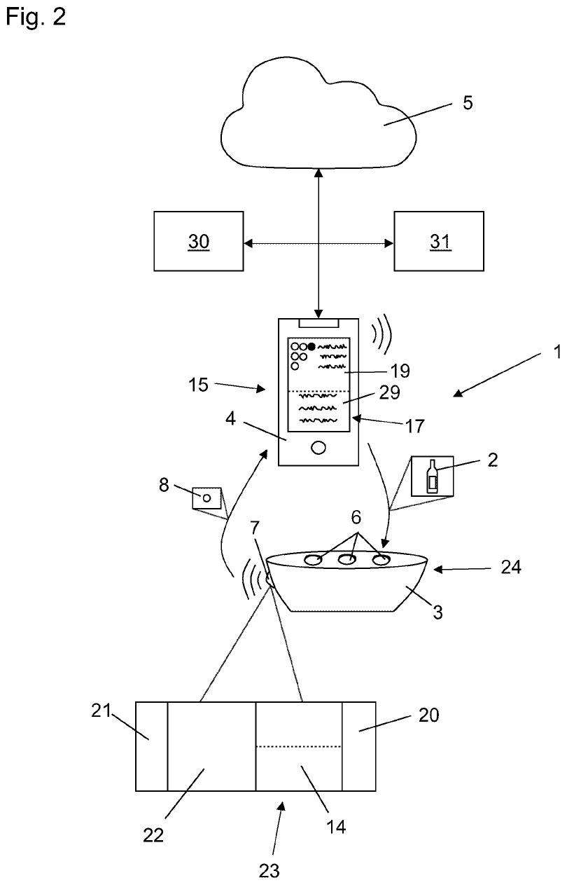

FIG. 2 shows a system 1, wherein the furniture part 3 is in the form of a container 24. In the schematically represented and enlarged detail section of the data transfer module 7 it can be seen that the data transfer module 7 comprises a receive device 20 for the identification, by radio signal transmission, of the smart tags 6 arranged on the at least one furniture part 3 and a send device 21 for the transmission, by radio signal transmission, of digital data sets 8. The data transfer module 7 comprises a computing unit 22 and a storage unit 23, wherein a portion of the storage unit 23 represents a buffer 14 for the interim storage of digital data sets 8.

The data transfer module 7 is set up, in dependence on a configuration by a user of the system 1, —to identify, iteratively or jointly, all smart tags 6 arranged on the furniture part 3 by communicating with the respective smart tags 6 —to transfer exactly one digital data set 8 relating to all smart tags 6 arranged on the furniture part 3 collectively to the mobile terminal 4 —to transfer, iteratively, digital data sets 8 relating in each case to exactly one smart tag 6 arranged on the furniture part 3 to the mobile terminal 4 —to store the digital data set 8, initiated by placing smart tags 6 on the furniture part 3, in the buffer 14 that is integrated in the data transfer module 7, wherein the buffer 14 can be emptied via the mobile terminal 4 or through a data transfer from the data transfer module 7 to the mobile terminal 4 —to initiate a data transfer of the digital data set 8 in the case of a query through the mobile terminal 4 —to initiate a data transfer of the digital data set 8 when a connection to the mobile terminal 4 is produced or when a number of smart tags 6 arranged on the furniture part 3 changes

The mobile terminal 4 is set up to automatically create a shopping list 19 based on the digital data sets 8 and taking into consideration a number of smart tags 6 on the goods 2. A data analysis of the digital data sets 8 can be generated taking into consideration a history of digital data sets 8 and predicted digital data sets 8.

In the cloud 5, based on the digital data sets 8, the smart tags 6 can be categorized, digital messages 18 can be transmitted to the mobile terminal 4, the shopping list 19 can be automatically created taking into consideration the number of smart tags 6 on the goods 2 and a data analysis of the digital data sets 8 can be generated taking into consideration the history of digital data sets 8 and predicted digital data sets 8.

By way of example, a method for the inventory monitoring of goods 2 can be effected using the system 1 through the following method steps: —a smart tag 6 out of the plurality of smart tags 6 is arranged directly on the good 2 that is spatially separate from the furniture part 3, —the smart tag 6 is arranged, after consumption of the good 2, directly on the furniture part 3 and —the data transfer module 7, arranged on the furniture part 3, of the furniture part 3 transfers digital data set 8 relating to the smart tag 6 arranged on the furniture part 3 to the mobile terminal 4.

The mobile terminal 4 can then relay the digital data set 8 to the cloud 5, whereby—based on the digital data set 8 in the cloud 5 after a data transfer of the digital data set 8 from the mobile terminal 4 into the cloud 5, and in dependence on a desired configuration of the cloud 5 by the user of the system 1, —a smart tag 6 is identified with a good 2 and a smart tag 6 is programmed for 1:1 identification with the good 2 —the digital data set 8 is visualized and the smart tags 6 are categorized based on the digital data set 8, wherein a digital message 18 is output on the mobile terminal 4 based on the digital data set 8 —the shopping list 19 is automatically created based on the digital data set 8 and taking into consideration the number of smart tags 6 on the goods 2 —a data analysis of the digital data set 8 is generated taking into consideration a history of digital data sets 8 and predicted digital data sets 8,

wherein individual or all process steps can also be carried out by the user on the mobile terminal 4, in dependence on a configuration of the mobile terminal 4, via the app 17 for monitoring the smart tags 6 stored on the mobile terminal 4.

With reference to the data analysis, in a user-specific and decentralized manner with respect to the system 1, a statistical evaluation of digital data sets 8 can be created, advertising 29 adapted to the digital data sets 8 can be visualized on the mobile terminal 4 and the digital data sets 8 can be relayed to production facilities 30 or sales facilities 31.

### LIST OF REFERENCE NUMBERS

system (1)
good (2)
furniture part (3)
mobile terminal (4)
cloud (5)
smart tag (6)
data transfer module (7)
digital data set (8)
switch (9)
router (10)
RFID chips (11)
NFC tags (12)
chips (13)
buffer (14)
smartphone (15)
computer (16)
app (17)
digital message (18)
a shopping list (19)
receive device (20)
send device (21)
computing unit (22)
storage unit (23)
container (24)
drawer (25)
separating device (26)
separating area (27)
securing device (28)
advertising (29)
production facility (30)
sales facility (31)

1. A system for the inventory monitoring of goods, comprising:
at least one, in particular movable, furniture part,
at least one good, in particular foodstuff, wherein the at least one good is, preferably spatially, separate from the at least one furniture part,
at least one mobile terminal and
a plurality of smart tags for the identification of the at least one good,
wherein, out of the plurality of smart tags, at least one smart tag is and/or can be arranged, preferably directly, on the at least one furniture part and/or is and/or can be removed from the at least one furniture part and the at least one furniture part comprises at least one data transfer module, wherein the at least one data transfer module is set up to transfer at least one digital data set relating to at least one smart tag that is and/or can be arranged on the at least one furniture part and/or is and/or can be removed from the at least one furniture part to the at least one mobile terminal.

2. The system according to claim 1, wherein a switch, a router and/or a cloud is provided, wherein the at least one digital data set can be relayed from the at least one furniture part to the at least one mobile terminal via the switch, the router and/or the cloud.

3. The system according to claim 1, wherein at least one smart tag is in the form of an RFID chip, an NFC tag and/or a, preferably programmable, chip.

4. The system according to claim 1, wherein the at least one data transfer module is set up:
to identify, preferably iteratively or jointly, all smart tags arranged on the at least one furniture part by communicating with the respective smart tags and/or
to transfer exactly one digital data set relating to all smart tags arranged on the at least one furniture part collectively to the at least one mobile terminal and/or
to transfer, iteratively, digital data sets relating in each case to exactly one smart tag arranged on the at least one furniture part to the at least one mobile terminal and/or
to store the at least one digital data set, preferably initiated by placing at least one smart tag on the at least one furniture part, in a buffer integrated in the at least one data transfer module, wherein it is preferably provided that the buffer can be at least partially emptied via the at least one mobile terminal and/or through a data transfer from the at least one data transfer module to the at least one mobile terminal, and/or
to initiate a data transfer of the at least one digital data set in the case of a query through the at least one mobile terminal and/or
to initiate a data transfer of the at least one digital data set when a connection to the at least one mobile terminal is produced and/or when a number of smart tags arranged on the at least one furniture part changes.

5. The system according to claim 1, wherein the at least one mobile terminal is formed as a smartphone, tablet and/or computer, preferably notebook or laptop, wherein it is preferably provided that at least one app for monitoring the plurality of smart tags is stored on the at least one mobile terminal, wherein, with the at least one app, at least one smart tag can be identified with at least one good and/or at least one smart tag can be programmed for identification, particularly preferably 1:1 identification, with at least one good.

6. The system according to claim 1, wherein the at least one mobile terminal is formed to visualize the at least one digital data set and/or to categorize the plurality of smart tags based on the at least one digital data set, wherein it is preferably provided that a digital message can be output on the at least one mobile terminal based on the at least one digital data set.

7. The system according to claim 1, wherein the at least one mobile terminal is set up to create, preferably automatically, a shopping list based on the at least one digital data set and possibly taking into consideration a number of smart tags on the at least one good, wherein it is preferably provided that a data analysis of the at least one digital data set can be generated, particularly preferably taking into consideration a history of digital data sets and/or predicted digital data sets.

8. The system according to claim 1, wherein the at least one mobile terminal is set up to transfer the at least one digital data set to a cloud, preferably via a possibly present switch and/or a possibly present router, wherein it is preferably provided that, in the cloud, based on the at least one digital data set,
the plurality of smart tags can be categorized, and/or
a digital message can be transmitted to the at least one mobile terminal, and/or
a shopping list can be created, preferably taking into consideration a number of smart tags on the at least one good and/or automatically, and/or
a data analysis of the at least one digital data set can be generated, preferably taking into consideration a history of digital data sets and/or predicted digital data sets.

9. The system according to claim 1, wherein the at least one data transfer module comprises a receive device for the identification, by radio signal transmission, of the smart tags arranged on the at least one furniture part and/or a send device for the transmission, by radio signal transmission, of the at least one digital data set, wherein it is preferably provided that the at least one data transfer module comprises a computing unit and/or a storage unit, particularly preferably buffer.

10. The system according to claim 1, wherein the at least one furniture part is formed in the form of a container and/or a drawer, wherein it is preferably provided that the at least one furniture part comprises a separating device for the at least one smart tag arranged on the at least one furniture part, wherein it is preferably provided that at least one separating area for configured smart tags, at least one separating area for unconfigured smart tags and/or at least two separating areas for placing smart tags of at least two different groups and/or at least one securing device for the at least one smart tag is provided on the at least one furniture part.

11. The system according to claim 1, wherein the at least one data transfer module is an integral part of the at least one furniture part and/or is integrated at least in areas, preferably entirely, in the at least one furniture part or arranged inside the at least one furniture part.

12. A method for the inventory monitoring of goods, in particular using the system according to claim 1, comprising the following method steps, to be carried out in particular in chronological order:
at least one smart tag out of a plurality of smart tags is possibly arranged, preferably directly, on a good, preferably foodstuff, that is, preferably spatially, separate from at least one, preferably movable, furniture part,
the at least one smart tag is arranged, in particular after consumption of the at least one good and/or directly, on the at least one furniture part and
at least one data transfer module, arranged on the at least one furniture part, of the at least one furniture part transfers at least one digital data set relating to the at least one smart tag arranged on the at least one furniture part to at least one mobile terminal, preferably smartphone, tablet and/or computer.

13. The method for the inventory monitoring of goods, in particular using the system according to claim 1, comprising the following method steps, to be carried out in particular in chronological order:
at least one smart tag out of a plurality of smart tags is removed from the at least one furniture part and possibly arranged on at least one good that is separate from the at least one furniture part and
at least one data transfer module, arranged on the at least one furniture part, of the at least one furniture part transfers at least one digital data set relating to the at least one smart tag removed from the at least one furniture part to at least one mobile terminal, preferably smartphone, tablet and/or computer.

14. The method according to claim 12, wherein, based on the at least one digital data set, on the at least one mobile terminal, via at least one app for monitoring the plurality of smart tags stored on the at least one mobile terminal, and/or in the cloud, after a data transfer of the at least one digital data set from the at least one mobile terminal into the cloud,
at least one smart tag is identified with at least one good and/or at least one smart tag is programmed for identification, particularly preferably 1:1 identification, with at least one good and/or
at least one digital data set is visualized and/or the plurality of smart tags are categorized based on the at least one digital data set, wherein it is preferably provided that a digital message is output on the at least one mobile terminal based on the at least one digital data set, and/or
a shopping list is created, preferably automatically, based on the at least one digital data set and possibly taking into consideration a number of smart tags on the at least one good, and/or
a data analysis of the at least one digital data set is generated, preferably taking into consideration a history of digital data sets and/or predicted digital data sets.

15. The method according to claim 14, wherein, on the basis of the data analysis, preferably in a user-specific and/or decentralized manner, a statistical evaluation of at least one digital data set is created, advertising adapted to the at least one digital data set is visualized on the at least one mobile terminal and/or the at least one digital data set is relayed to at least one production facility and/or sales facility.

16. A computer program product, comprising commands which, when executed by a computing unit, prompt the latter to transfer at least one digital data set relating to at least one smart tag that is arranged on, able to be arranged on, removed from and/or able to be removed from the at least one furniture part from a storage unit, which is or can be brought into data connection with the computing unit, to at least one mobile terminal for carrying out the method according to claim 12.

17. A data carrier signal which carries the computer program product according to claim 16.

18. A storage medium, in particular non-volatile storage medium, comprising commands which, when executed by a computing unit, prompt the latter to transfer at least one digital data set relating to at least one smart tag that is arranged on, able to be arranged on, removed from and/or able to be removed from the at least one furniture part to at least one mobile terminal for carrying out the method according to claim 12.
